(19) United States
(12) Patent Application Publication
(10) Pub. No.: US 2009/0061406 A1
(43) Pub. Date: Mar. 5, 2009

(54) CONSTRUCTING A PROFILE USING SELF-DESCRIPTIVE IMAGES FOR USE IN A SOCIAL ENVIRONMENT

(75) Inventors: Gary Bruce Clayton, Daly City, CA (US); Victor Shine Chen, Saratoga, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/845,989

(22) Filed: Aug. 28, 2007

(51) Int. Cl. G09B 19/00

(52) U.S. Cl. 434/322

(57) ABSTRACT

Methods and apparatus are described in which a plurality of sensory stimuli are presented to a user. A response from the user to each of selected ones of the sensory stimuli is recorded where the response is given within a period of time from the presentation of the corresponding sensory stimulus. The period of time is selected to increase the likelihood that the recorded responses are spontaneous.

### BACKGROUND OF THE INVENTION

1. Field of the Invention

The present invention relates to systems, methods, and computer program products for constructing a profile and/or persona for use in a social environment. More specifically, the present invention relates to systems, methods, and computer program products for constructing a profile and/or persona using first-impression-type responses to sensory stimuli, such as images or sounds.

2. Background of the Invention

The Internet provides a robust and convenient social environment where people from all over the world may interact socially and/or professionally. With the help of the Internet, communications between people everywhere are fast, easy, and inexpensive. Internet services such as email, chat, short message, etc. often enable people to communicate with each other almost in real time. Physical distances no longer present any significant barriers. Furthermore, in addition to text and voice messages, people may share image, audio, and/or video files via the Internet.

Taking advantage of the Internet's versatility, many websites provide various social platforms or environments for people to interact with each other via the Internet. For example, Yahoo!® Groups hosts subject-matter-oriented discussion groups so that people who are interested in the same or similar subject matter may form and join specific groups to discuss the subject matter which is of particular interest to them. Other websites, such as Google™ Groups or iGroops™, provide similar services. Internet dating and friend-finding are other popular types of social services. Some of the popular websites providing dating and/or friend-finding services include Yahoo!® Personals and match.com®.

Often, in order to participate at these social websites, a person needs to create a profile or persona so that other participants may decide whether or not to interact with him or her. The profile describes the person or projects a self-image representing the person to the other participants.

Usually, a person wishing to participate at these social websites needs to become a registered user of the websites and create a personal account first. Each user may then describe himself or herself by providing personal information such as age, gender, education, sexual orientation, geographical location, interests, hobbies, etc. Such personal information may be a part of the profile or persona for the corresponding user and be used to find one or more potential matches, e.g., friends or dates, for the user. In addition, the systems hosting the social websites may ask the user a series of questions designed to learn more about the user's background, personality, and characteristics. These questions may cover a broad range of topics. For example, the questions may relate to the user's hobbies or interests, religious or political views, personal habits, financial situations, career goals, family plans, etc. The questions may also be designed to obtain insights on the user's personality, such as asking the user how he or she feels about certain ideas, objects, his or her likes and dislikes, etc. The answers to these questions may be used to construct the profile or persona for the user.

However, such a profile may not always truly reflect the user's personality and characteristics. Sometimes, a user may answer certain questions in a way that he or she believes they should be answered or are expected to be answered, instead of in the way he or she honestly feels. Sometimes, the questions may be ambiguous or confusing such that different users may interpret the same question differently and answer according to their own interpretations.

Accordingly, what are needed are systems and methods to improve the accuracy of constructing a social profile for use in a social environment.

### SUMMARY OF THE INVENTION

Broadly speaking, the present invention relates to systems and methods for constructing a profile for use in a social environment.

According to various specific embodiments of the invention, methods and apparatus are provided in which a plurality of sensory stimuli are presented to a user. A response from the user to each of selected ones of the sensory stimuli is recorded where the response is given within a period of time from the corresponding sensory stimulus. The period of time is selected to increase the likelihood that the recorded responses are spontaneous.

In addition, the user may adjust the period of time for responding to the sensory stimuli and may modify any of the recorded responses. Alternatively, the period of time for responding to the sensory stimuli may be adjusted automatically based on a user's performance in responding to the sensory stimuli. The recorded responses to the sensory stimuli may be used to construct a profile for the user for use in a social environment, such as, for example, to find potential opportunities for social interaction for the user.

These and other features, aspects, and advantages of the invention will be described in more detail below in the detailed description and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a method of recording a person's responses to a series of sensory stimuli and using the recorded responses to find potential opportunities for social interaction for the person.

FIG. 2 illustrates an example of a user interface that enables a user to respond to a series of sensory stimuli.

FIG. 3 illustrates an example of a user interface that enables a user to interact with other users within a social environment.

FIG. 4 is a simplified diagram of a network environment in which specific embodiments of the present invention may be implemented.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. In addition, while the invention will be described in conjunction with the particular embodiments, it will be understood that it is not intended to limit the invention to the described embodiments. To the contrary, it is intended to cover alternatives, modifications, and equivalents as may be included within the spirit and scope of the invention as defined by the appended claims.

As people interact with each other in an Internet-based social environment, it is often useful, even necessary, to construct a profile for each person. Such profiles may be used in many ways. To begin with, for example, each individual's profile tells the others the kind of person he or she is, as people socializing on the Internet often do not have the opportunities to socialize in person. Profiles may be used to find potential friends and romantic matches or to bring people with similar interests together.

To construct a profile according to specific embodiments of the invention, a series of sensory stimuli is presented to a person. The sensory stimuli may include a wide variety of visual and auditory stimuli such as, for example, images, audio clips, video clips, etc. Often, each stimulus is selected to convey a message, a feeling, an idea, an emotion, etc., and is intended to elicit a personal response from the person. To help avoid ambiguity or misinterpretation, the stimuli are preferably self descriptive. That is, there is an intended meaning feeling, idea, emotion, topic, etc. that it is conveyed by each stimulus more clearly than if the intended meaning, feeling, idea, emotion, topic, etc., were to be communicated only linguistically, e.g., only with text. Another way to think about the self-descriptive nature of the stimuli which are preferable for use with embodiments of the invention is that they are relatively self-explanatory.

The person is given two or more choices for each stimulus from which he or she may choose a response. For example, the choices may be “like it” or “hate it.” Or, the choices may be “like it,” “hate it,” or “neutral.” Alternatively, the person may be asked to rate the stimulus on a scale having more than two options, e.g., a scale from 1 to 5. Preferably, the person has a relatively short period of time to choose each response after the stimulus is presented to increase the likelihood that the person's responses are spontaneous, i.e., the first thought or feeling that comes to the person's mind after experiencing, e.g., hearing, seeing, touching, etc., each stimulus. One of the reasons for allotting only a short time period for the person to respond is to increase the likelihood that the person's responses are more honest. That is, the person does not have enough time to consider and “spin” his or her responses. This is based on the assumption that first impressions and spontaneous responses typically more accurately represent what the person truly feels about the stimuli.

According to a specific embodiment, only those responses given within the allotted time are recorded. Subsequently, the set of responses is used to represent the person's character, personality, psychology, etc. The set of responses may then be used to identify opportunities for social interaction, e.g., find friends, dates, social groups, etc.

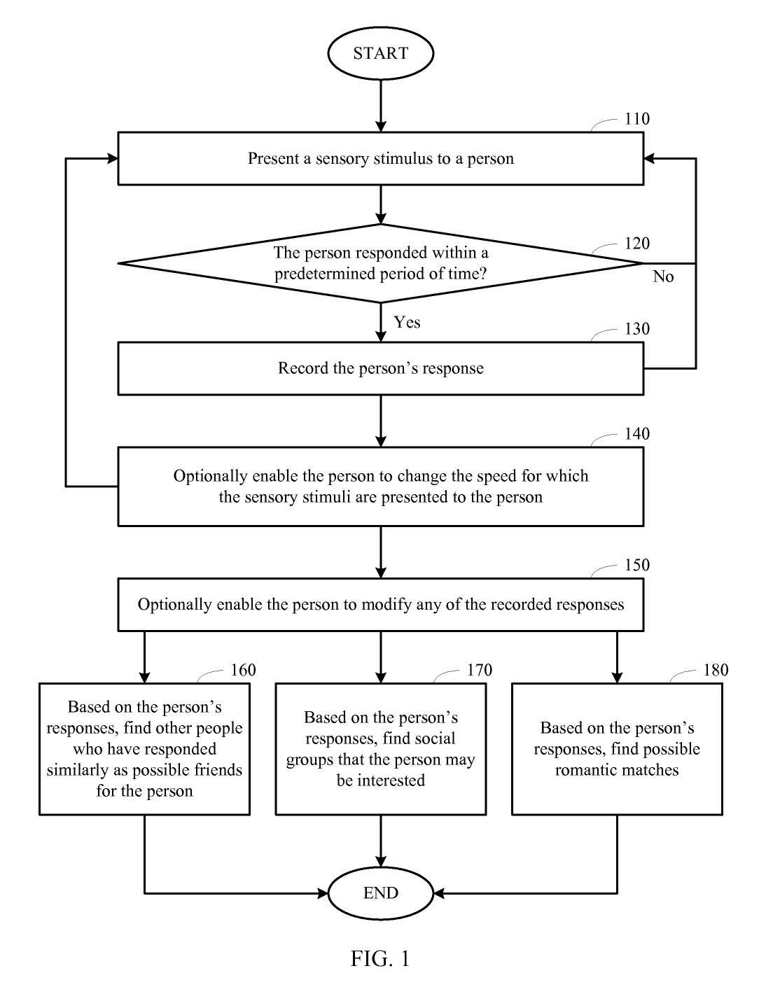

FIG. 1 illustrates a method of recording a person's responses to a series of sensory stimuli and using the recorded responses to identify opportunities for social interactions according to a particular embodiment. Assume a person wishes to participate in one or more Internet-based social forums or environments, to meet new friends, to form romantic relationships, to establish business connections, etc. As a way to introduce himself or herself to the other participants of the Internet community, the person may wish to construct a profile. The profile may represent a self-image that the person projects to the community.

At 110, a sensory stimulus is presented to the person. The sensory stimulus may be an image, an audio or video clip, a smell, a touch, a taste, etc. In fact, the sensory stimulus may be any sensory input which may be detected by human senses, e.g., sight, sound, touch, smell, taste, etc. Usually, the sensory stimulus is selected to convey an idea, a feeling, an emotion, a message, etc. Preferably, the sensory stimulus is self-explanatory and unambiguous in presenting whatever it is trying to convey to the person in order to minimize the possibility of misunderstanding.

For example, in order to determine whether the person enjoys classical art, an image of a painting by Da Vinci or a sculpture by Michelangelo may be presented to the person. Or, to determine whether the person enjoys jazz music, a sound clip of some music by Duke Ellington or Glenn Miller may be used. Similarly, to determine whether the person likes action films, a video clip of an action sequence from a popular James Bond film may be used. Other expressive or descriptive stimuli, such as a Starbucks® or McDonalds® logo, images of beach resorts, sport cars, models, political or religious slogans, etc., may also be used to solicit responses to a wide variety of topics or subject matter.

Although the length of the presentation of a particular stimulus may be for any period of time, preferably the stimulus should be presented for a relatively short period of time. By keeping exposure to the stimulus relatively short, the person does not have much time to consider his or her response. This helps to increase the likelihood that the person's response is spontaneous (and therefore, presumably, more honest).

After the sensory stimulus is presented to the person, the person may be given some additional time to choose a response, especially when the sensory stimulus is, for example, an audio or video clip. Again, the time period is selected to increase the likelihood that the person's response is spontaneous, i.e., a first impression of the stimulus. The person should select the first response that comes to his or her mind without giving too much thought. According to a specific embodiment, the time period is limited to a few seconds, e.g., 3 to 5 seconds, after the stimulus has been presented.

In addition, preferably, the number of choices from which the person may choose a response is relatively small, e.g., 2 or 3 choices. Alternatively, embodiments are contemplated in which the number of choices is larger, e.g., scale from 1 to 10 or 100, or even a representation of a two or three-dimensional space in which the person selects a location representative of his or her response. As will be understood, the number of response choices, and or the manner in which they are represented may vary considerably without departing from the scope of the invention.

As indicated above, in practice, there is no specific limitation on the actual number of choices given. However, by keeping the number of choices small, it is not necessary for the person to spend too much time thinking about his or her choice of response. This again helps the person to choose the first response that comes to his or her mind without requiring too much conscious thought. For example, the person may be provided with two choices: like it or hate it, or three choices: like it, hate it, or neutral.

At 120, a determination is made as to whether the person has chosen a response within the allotted time period. If the person has responded within the allotted time period, then at 130, the person's response is recorded. Otherwise, the person's response is discarded. Thereafter, a new sensory stimulus is presented to the person and steps 110, 120, and 130 are repeated.

There is no specific limit on how many times steps 110, 120, and 130 should be repeated. On the other hand, although a few responses, or even a single response, may offer some insight into the person's background, personality, psychology, characteristics, etc., a larger number of responses generally represents a more accurate and complete picture of the person. Thus, preferably, a relatively larger number of stimuli covering a wide variety of topics should be presented in order to solicit multiple responses on multiple topics from the person.

It is not necessary for the person to supply all the responses at once. The person may supply some responses, and then stop for some period of time. Later, the person may resume the process and be presented with additional stimuli. The person may choose to repeat steps 110, 120, and 130 at his or her convenience and as often as he or she chooses.

Furthermore, although the stimuli are preferably self-explanatory, it is not always easy to avoid ambiguity in the ideas or messages suggested by the stimuli. For example, an image of a beach with a few people surfing in the background may convey the feeling of leisure and vacation to one person, but water sports, i.e., surfing, to another. To help avoid ambiguity, multiple stimuli of the same theme or similar themes may be presented. For example, if the purpose is to determine whether the person likes outdoor sports and activities, several images of different outdoor sports and activities, e.g., mountain climbing, hiking, beach volleyball, horseback riding, etc., may be presented. If the person responds positively to most of these images, then it may indicate that the person likes outdoor activities in general. Similarly, if the purpose is to determine whether the person likes sports cars, multiple images of sports cars of different brands and models as well as short video clips of car races may be presented to the person. More generally, where a response to a particular stimulus might lend itself to varying interpretations, subsequent stimuli may be selected in response to the person's response to the first stimulus and then presented with the intent to mitigate the potential for ambiguity.

Even more generally, specific stimuli within the series of stimuli presented may be selected, at least in part, with reference to the person's responses themselves. For example, if the person consistently responds negatively to a particular category of subject matter, e.g., sports, fashion, etc., stimuli relating to that subject matter may be subsequently omitted from the sequence. Conversely, if a person consistently responds positively to a particular category of subject matter, additional stimuli relating to that subject matter may be added to the sequence to refine the person's profile or persona.

Not all people respond to sensory stimuli the same way. Some people may respond quicker than others. For example, if the response time period is set to 3 seconds, for some people, it may be long enough to choose a response for each stimulus, while for other people, it may not. Thus, at 140, optionally, the person may adjust the time period for selecting a response and change the speed for which the sensory stimuli are presented, as the faster the stimuli are presented, the less time the person has to choose a response. People who are able to respond quickly may shorten the response time, and people who need more time to respond may lengthen the response time as necessary.

Alternatively, the time period for selecting responses may be automatically adjusted in response to the person's recorded ability to respond. That is, for example, if it is determined that the person is only responding to a small number of the stimuli, e.g., 1 in 5 or 1 in 10, the response time may be lengthened to enable the person to respond to a greater number of stimuli. On the other hand, if the person is able to respond to most of the stimuli well within the response time allotted, the response time could be automatically shortened to better ensure that the person's responses are spontaneous.

Thereafter, the sensory stimuli may be presented to the person in a speed according to the adjusted response time. Additionally, the time period for response may be periodically or occasionally adjusted as appropriate.

Sometimes, the person may wish to change one or more responses already recorded, perhaps for privacy reasons or perhaps the person has changed his mind. At 150, the person is given the means to modify any recorded responses as desired. Once the modifications are completed, the person may choose to continue with the stimuli presentation or may proceed to finding possible social interactions.

Once the person's responses have been collected, they may be used in different ways. For example, the recorded responses may form the basis of a profile for the person for use in a social environment. For example, at 160, the responses may be used to find potential friends who have responded similarly to the stimuli. For example, if the person indicates that he or she likes sports by responding positively to images or video clips of various sport activities, other people who also like sports, i.e., also responding positively to images or video clips of various sport activities, may be good candidates for the person to socialize with. Similarly, if both person A and person B like jazz music and respond positively to audio clips of jazz music, person A may wish to learn from person B what other things person B likes, since it is possible that person A may enjoy those things as well. In a different scenario, if both person A and person B likes the same type of cuisine, if person A has a chance to visit the city where person B lives or is familiar with, person A may ask person B for recommendations on local restaurants, since both of them have similar taste in food.

At 170, the responses may be used to find online social groups in which the person may be interested. For example, if the person indicates that he or she likes poetry, he or she may be interested in literary groups. Or, if the person indicates that he or she likes fishing, he or she may be interested in groups that focus on fishing and related activities.

If the person is looking for romantic relationships, then at 180, the responses may be used to find possible matches for the person. Generally, people who enjoy similar things or have similar backgrounds may be good matches for each other. When finding possible romantic connections for the person, both parties' responses may be taken into consideration and compared for similarities.

For example, the recorded responses indicate a person's likes and dislikes toward various subject matter. By comparing the recorded responses from two people, it may be determined whether they like and dislike similar things. Thus, if both people responded positively to audio clips of jazz music, it may be an indication that both people enjoy jazz music. Conversely, if both people responded negatively to images of classical art, it may be an indication that both people dislike classical art. A match may be established if some percentage of the responses from two people is the same. Of course, the greater the percentage, the closer the match. The actual percentage value may be chosen depending on how closely the two people should be matched.

Thus, a profile constructed in accordance with the invention may be as simple as the set of responses or the set of stimuli to which the user responded in a positive manner. In such embodiments, identification of other individuals or groups who may be considered matches or compatible with the user may also be relatively straightforward, e.g., as simple as identifying others for whom many of the same responses to the same or similar stimuli were recorded.

Alternatively, embodiments are contemplated in which the set of responses is used as input to one or more further processes to derive a profile. For example, psychological theory and/or personality inventory tools may be applied to a user's set of responses to identify personality traits which may be used as the basis for the user's profile.

Once a profile has been constructed for the person based on his or her responses, the profile may be shared across multiple social networking websites. Different websites may focus on different aspects of the profile. For example, if a person's profile indicates that the person likes red wine, travel, and romantic literature, a website that focuses on food and wine may recommend various brands of red wine to the person, while a travel website may recommend various travel itineraries to the person. Similarly, the food and wine website may introduce other people who also enjoy red wine to the person while the travel website may introduce travel companions to the person. Meanwhile, a third website may recommend book clubs or literary groups to the person.

Although the method described in FIG. 1 mainly focuses on constructing profiles for use in an Internet-based social environment, the techniques described herein may be extended to other applications as well. For example, embodiments of the invention may be implemented in the context of marketing research, such as with focus groups. A focus group is an important tool for acquiring feedback from potential consumers regarding a product, a service, a concept, a business idea, etc. According to some embodiments of the invention, instead of asking people in a focus group questions, sensory stimuli describing the product, service, concept, or idea in question may be presented to the members of the group. A set of spontaneous responses to the stimuli may then be recorded. By getting spontaneous responses about the subject matter of the focus study from the group, researchers may be able to obtain more accurate (and therefore more useful) feedback regarding how people truly feel about the product, service, concept, or idea.

The method described in FIG. 1 may be implemented as a computer software program. The program may be executed through a web browser or as an application program that may be executed on a computer, a personal digital assistant (PDA), a mobile telephone, a media player, etc. The program may be designed and implemented as a game. People may play such games at their leisure, and a large number of responses may be accumulated over time. The person may be required to become a registered user at website before he or she may use the program to construct a person.

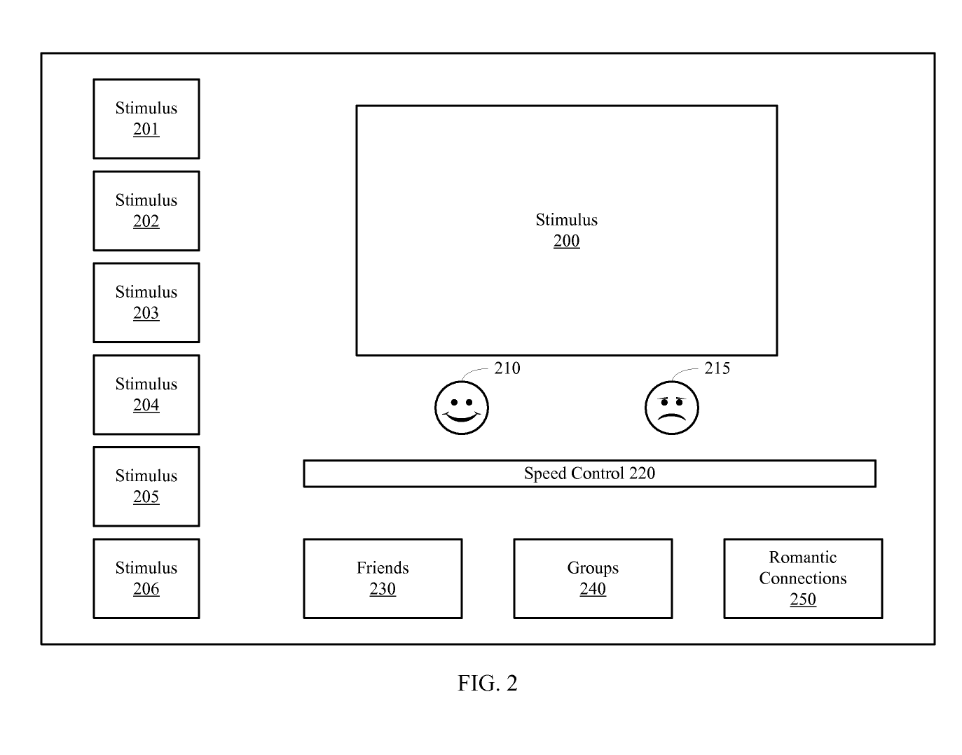

FIG. 2 illustrates an example of a user interface that enables a user to respond to a series of sensory stimuli. Of course, different implementations may employ different user interface designs. In FIG. 2, the stimuli may be presented to the user one at a time 200. In this design, the user may respond to each stimulus 200 in one of two ways. If the user likes the stimulus 200, he or she may click the “happy face” icon 210 within the allotted time. Otherwise, he or she may click the “sad face” icon 215.

On the left is a list of stimuli 201, 202, 203, 204, 205, 206 to which the user has responded positively within the allotted time. This provides an historical record to the user and allows the user to see which stimuli he or she likes.

Below the respond icons 210, 215 is a speed control slider 220. If the user wishes to shorten the response time, he or she may slide the speed control bar 220 to the right to increase the speed for presenting the stimuli. Conversely, if the user wishes to lengthen the response time, he or she may slide the speed control bar 220 to the left. The person may adjust the slider 220 at any time during the presentation of the stimuli. Once the slider 220 has been adjusted, the stimuli are presented at the new speed. Alternatively, and as discussed above, the response time may also be adjusted automatically in response to, for example, the speed with which the person responds to the stimuli, or the number of stimuli to which the person was able to respond.

In addition, there are three areas 230, 240, 250 near the bottom of the user interface. The “Friends” area 230 may list those people who responded to the stimuli similarly as the user. These people may potentially become the user's friends. The “Group” area 240 may list Internet-based social groups that the user may wish to join. The “Romantic Connections” area 250 may list those people who may be possible matches for the user based on both parties' responses. Of course, if the user is not seeking any romantic connections, he or she may ignore this area and/or disable it.

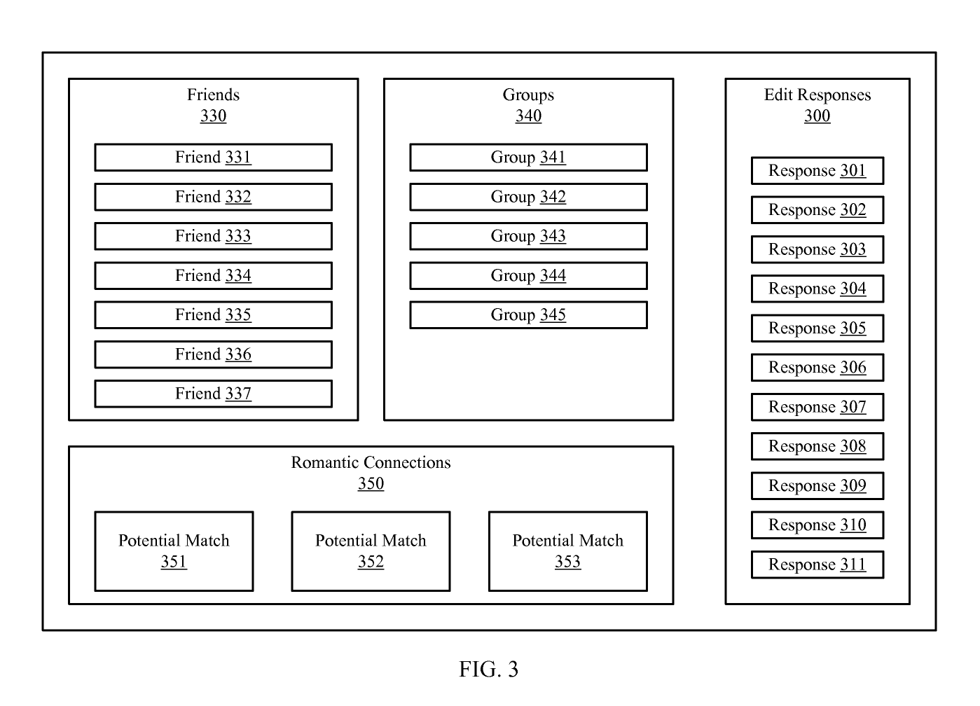

The three areas 230, 240, 250 may be expanded so that the user may obtain more detailed information. For example, FIG. 3 illustrates an example of a user interface that enables a user to interact with other users within a social environment.

In this example, the user interface is divided into four areas. Under the “Friends” area 330, those people 331, 332, 333, 334, 335, 336, 337 who responded similarly to the stimuli as the user are listed. Each potential friend's profile may be described so the user may choose whether or not to socialize with the individual. Under the “Groups” area 340, those groups 341, 342, 343, 344, 345 in which the person may be interested are listed. Information about each group, such as the group's interest or focus, may be described. And under the “Romantic connections” area 350, the possible romantic matches are listed along with each person's information. Again, information on each potential match 351, 352, 353 may be presented so the user may choose with which person to interact.

In addition, the user's recorded responses 301, 302, 303, 304, 305, 306, 307, 308, 309, 310, 311 are listed on the right of the user interface under the “Edit Response” area 300. The user may select any previously recorded response to edit the response.

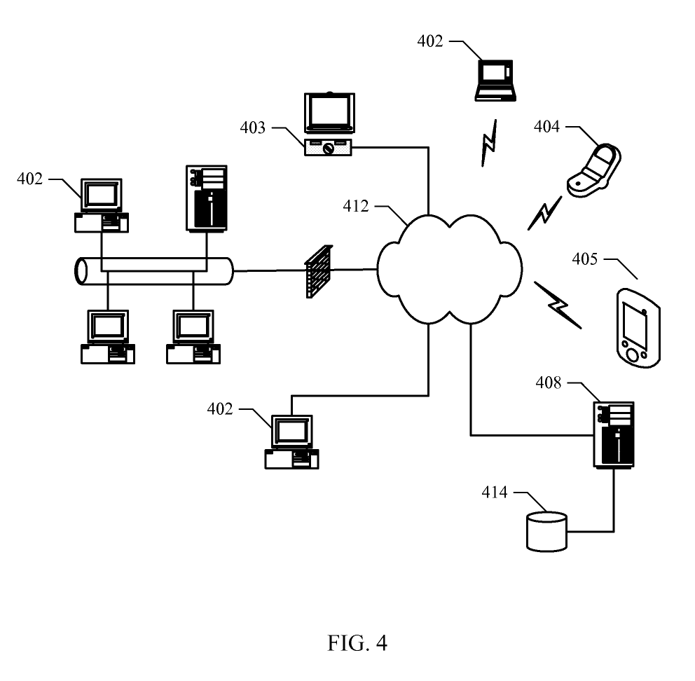

FIG. 4 is a simplified diagram of an example of a network environment in which specific embodiments of the present invention may be implemented. The various aspects of the invention may be practiced in a wide variety of network environments (represented by network 412) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations. All or a portion of the software program implementing various embodiments may be executed on the server 408. Similarly, a website providing the social environment may be hosted on the server 408 or by one of the computers 402, 403.

The responses from the each of the users may be stored in one or more databases such as database 414. These responses may be used to find potential social matches for the users. Similarly, the sensory stimuli may also be stored in one or more databases.

The software presenting the sensory stimuli and recording the responses may be executed on any of the computing devices connected to the network, such as computers 402, 403, mobile telephone 404, PDA 405, server 408, etc. A user may submit responses to the sensory stimuli and the responses may be transmitted over the network to the database 414 for storage.

While this invention has been described in terms of several preferred embodiments, there are alterations, permutations, and various substitute equivalents, which fall within the scope of this invention. It should also be noted that there are many alternative ways of implementing the methods and apparatuses of the present invention. For example, despite the references to the Internet and virtual communities above, embodiments are contemplated in which most or even all of the functionalities described herein for generating a profile are performed on a single, stand-alone computing device. It is therefore intended that the following appended claims be interpreted as including all such alterations, permutations, and various substitute equivalents as fall within the true spirit and scope of the present invention.

1. A computer-implemented method, comprising:
presenting a plurality of sensory stimuli to a user; and
recording a response from the user to each of selected ones of the sensory stimuli,
wherein each recorded response is given within a period of time from the corresponding selected sensory stimulus, the period of time being selected to increase the likelihood that the recorded responses are spontaneous.

2. The method, as recited in claim 1, further comprising:
enabling the user to adjust any of the recorded responses.

3. The method, as recited in claim 1, further comprising:
adjusting the period of time.

4. The method, as recited in claim 3, wherein adjusting the period of time is done by the user.

5. The method, as recited in claim 1, further comprising:
recommending at least one social connection to the user based on the recorded responses of the user and additional recorded responses associated with the at least one social connection.

6. The method, as recited in claim 5, further comprising:
identifying the at least one social connection by comparing the recorded responses associated with the user and the additional recorded responses associated with the at least one social connection.

7. The method, as recited in claim 1, further comprising:
recommending at least one social group to the user based on the recorded responses of the user and a characteristic of the at least one social group.

8. The method, as recited in claim 1, further comprising:
presenting the plurality of sensory stimuli to each of a plurality of members of a focus group, wherein each of the plurality of sensory stimuli describes a subject matter of market research; and
recording a response from each member of the focus group to each of selected ones of the sensory stimuli.

9. A system comprising at least one computing device configured to:
present a plurality of sensory stimuli to a user; and
record a response from the user to each of selected ones of the sensory stimuli,
wherein each recorded response is given within a period of time from the corresponding selected sensory stimulus, the period of time being selected to increase the likelihood that the recorded responses are spontaneous.

10. The system, as recited in claim 9, wherein the at least one computing device is further configured to:
enable the user to adjust any of the recorded responses.

11. The system, as recited in claim 9, wherein the at least one computing device is further configured to:
adjust the period of time.

12. The system, as recited in claim 11, wherein adjust the period of time is done by the user.

13. The system, as recited in claim 9, wherein the at least one computing device is further configured to:
recommend at least one social connection to the user based on the recorded responses of the user and additional recorded responses associated with the at least one social connection.

14. The system, as recited in claim 13, wherein the at least one computing device is further configured to:
identify the at least one social connection by comparing the recorded responses associated with the user and the additional recorded responses associated with the at least one social connection.

15. The system, as recited in claim 9, wherein the at least one computing device is further configured to:
recommend at least one social group to the user based on the recorded responses of the user and a characteristic of the at least one social group.

16. The system, as recited in claim 9, wherein the at least one computing device is further configured to:
present the plurality of sensory stimuli to each of a plurality of members of a focus group, wherein each of the plurality of sensory stimuli describes a subject matter of market research; and
record a response from each member of the focus group to each of selected ones of the sensory stimuli.

17. A computer program product comprising a computer-readable medium having a plurality of computer program instructions stored therein, which are operable to cause at least one computing device to:
present a plurality of sensory stimuli to a user; and
record a response from the user to each of selected ones of the sensory stimuli,
wherein each recorded response is given within a period of time from the corresponding selected sensory stimulus, the period of time being selected to increase the likelihood that the recorded responses are spontaneous.

18. The computer program product, as recited in claim 17, wherein the plurality of computer program instructions are further operable to cause the at least one computing device to:
enable the user to adjust any of the recorded responses.

19. The computer program product, as recited in claim 17, wherein the plurality of computer program instructions are further operable to cause the at least one computing device to:
adjust the period of time.

20. The computer program product, as recited in claim 19, wherein adjust the period of time is done by the user.

21. The computer program product, as recited in claim 17, wherein the plurality of computer program instructions are further operable to cause the at least one computing device to:
recommend at least one social connection to the user based on the recorded responses of the user and additional recorded responses associated with the at least one social connection.

22. The computer program product, as recited in claim 21, wherein the plurality of computer program instructions are further operable to cause the at least one computing device to:
identify the at least one social connection by comparing the recorded responses associated with the user and the additional recorded responses associated with the at least one social connection.

23. The computer program product, as recited in claim 17, wherein the plurality of computer program instructions are further operable to cause the at least one computing device to:
recommend at least one social group to the user based on the recorded responses of the user and a characteristic of the at least one social group.

24. The computer program product, as recited in claim 17, wherein the plurality of computer program instructions are further operable to cause the at least one computing device to:
present the plurality of sensory stimuli to each of a plurality of members of a focus group, wherein each of the plurality of sensory stimuli describes a subject matter of market research; and
record a response from each member of the focus group to each of selected ones of the sensory stimuli.
